(19) United States
(12) Patent Application Publication
(10) Pub. No.: US 2020/0117740 A1
(43) Pub. Date: Apr. 16, 2020

(54) DATA ANALYTICS PLATFORM WITH INTERACTIVE NATURAL LANGUAGE QUERY INTERFACE

(71) Applicant: Bouquet.ai, San Francisco, CA (US)

(72) Inventors: Adrien Schmidt, San Rafael, CA (US); Marios Anapliotis, San Francisco, CA (US); Joffrey Villard, Lyon (FR)

(21) Appl. No.: 16/156,933

(22) Filed: Oct. 10, 2018

(51) Int. Cl. G06F 17/30

(52) U.S. Cl. CPC G06F 17/30554; G06F 17/30401; G06F 17/30867

(57) ABSTRACT

A data analytics system comprises a data source configured to store a plurality of data sets. A dialog manager generates a context-based data query responsive to identifying a context of a natural language query based, at least in part, on a prior natural language query within a conversation. An analytics engine is configured to run queries on the data source responsive to the context-based data query and then generate an output result. The dialog manager generates an interactive data visualization of the output result with a prompt for a follow-up query on the data source. The prompt for the follow-up query is related to the context of the natural language query.

### BACKGROUND

The use of bots (e.g., voice or chat bots) on the web or other communication platforms using natural language queries is becoming ubiquitous. Users look for quick and easy ways to obtain information from various data sources without having to interact with a human skilled in data analytics. Existing bots (e.g., voice or chat bots) employ a merely responsive approach to user queries. In other words, data is provided only in direct response to the user's question without initiating a dialogue. Responses are mere close-ended answers to the user query and fail to provide guidance to the user for further data queries.

There is a need for an AI-based bot that engages with users in a dialogue to discover insights into underlying data.

### SUMMARY

In one embodiment, a data analytics system comprises: a data source configured to store a plurality of data sets; a dialog manager to generate a context-based data query responsive to identifying a context of a natural language query based, at least in part, on a prior natural language query within a conversation; and an analytics engine configured to run queries on the data source responsive to the context-based data query and generate an output result, wherein the dialog manager is configured to generate an answer (e.g., natural language answer), preview of data underlying the answer (e.g., data snippet), and/or an interactive data visualization of the output result with a prompt for a follow-up query on the data source, the prompt for the follow-up query being related to the context of the natural language query. The follow-up query may, for example, be a likely “next-best” action to take based on the context of the natural language query.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several examples in accordance with the disclosure and are, therefore, not to be considered limiting of its scope, the disclosure will be described with additional specificity and detail through use of the accompanying drawings, in which:

FIG. 1A is a schematic illustration of a data analytics system, according to one illustrated embodiment.

FIG. 1B is a schematic illustration of a backend process implemented by the dialog manager to identify the elements relevant to the data source for implementing the context-based data query, according to one illustrated embodiment.

FIGS. 2-3 are screenshots from the dashboard depicting the widget providing follow-up analytics prompts to the user during a dialogue with the data analytics system, according to one illustrated embodiment.

FIG. 4 is an illustration of screenshots from the dashboard depicting sharing the dialogue with another user, according to one illustrated embodiment.

FIG. 5 is a screenshot from the dashboard depicting consecutive natural language queries (NLQs) during the user dialogue with the data analytics system 100, according to one illustrated embodiment.

FIG. 6 is an illustration of screenshots from the dashboard depicting the user dialogue with the data analytics system when the dialog manager prompts the user to assist in identifying an element in the natural language query (NLQ), according to one illustrated embodiment.

FIG. 7 is a schematic illustration of a process flow for processing an input query by the data analytics system, according to one illustrated embodiment.

FIG. 8 is a block diagram illustrating an example dialog manager arranged for identifying the NLQ elements relevant for generating context-based data queries of the data sets in the data source and causing display of a data visualization of the searched data with prompts for follow-up searches, according to one illustrated embodiment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

Various examples of embodiments of the invention will now be described. The following description provides specific details for a thorough understanding and enabling description of these examples. One skilled in the relevant art will understand, however, that embodiments of the invention may be practiced without many of these details. Likewise, one skilled in the relevant art will also understand that embodiments incorporate many other obvious features not described in detail herein. Additionally, some well-known structures or functions may not be shown or described in detail below, so as to avoid unnecessarily obscuring the relevant description.

The terminology used herein is to be interpreted in its broadest reasonable manner, even though it is being used in conjunction with a detailed description of certain specific examples of the invention. Indeed, certain terms may even be emphasized below; any terminology intended to be interpreted in any restricted manner will, however, be overtly and specifically defined as such in this Detailed Description section.

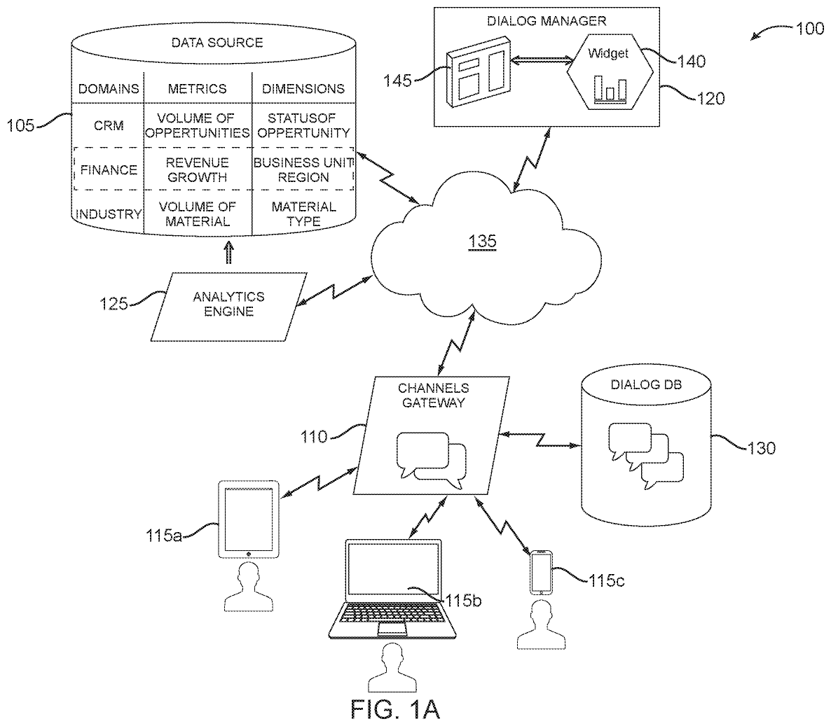

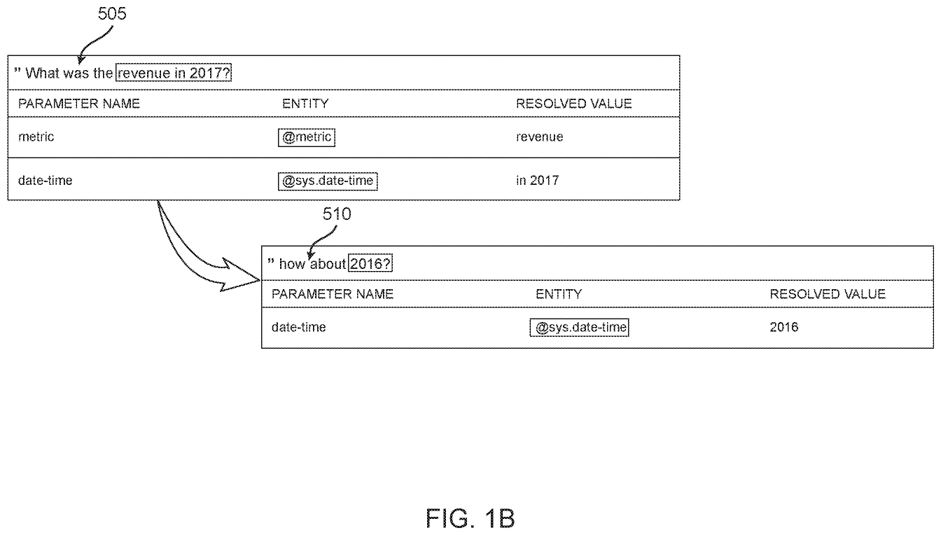

FIG. 1A shows a schematic illustration of a data analytics system 100, according to one illustrated embodiment. The data analytics system 100 may operate to receive natural language queries to retrieve select portions of data stored in a data source 105, and provide an output result including at least one of a natural language answer or interactive data visualization of the data. As will be described in more detail herein, the output result of the data analytics system 100 may be advantageously displayed to prompt a user to continue a dialogue with the data analytics system 100.

The data analytics system 100 may comprise a channels gateway 110 coupled to a plurality of user devices 115a, 115b, 115c (collectively referenced herein as 115), the data source 105, a dialog manager 120, an analytics engine 125, and a dialog database 130 communicatively coupled to one another via a network 135. The network 135 may, for example, comprise a Local Area Network (LAN), Wide Area Network (WAN), the Internet, Infrared, Bluetooth or Zigbee communication protocols, to name a few.

The data source 105 is configured to store data sets pertaining to one or more entities, such as for example businesses or industries that a user is involved in. In one example, the data source 105 may include the data sets associated with metadata to allow for the data sets to be queried. For example, the data sets may have metadata such as a set of domains, metrics, and dimensions (e.g., date range, geography, to name a few) that can be queried. In a relational database example, there may be tables of data for respective businesses having columns corresponding to the Metrics and Dimensions with rows corresponding to particular ones of the Domains. In the illustrated example of FIG. 1, the data source 105 includes a CRM (Customer Relationship Management), Finance, and Industry domains. It will be appreciated that these example domains provide context to the associated Metrics and Dimensions. The metrics and dimensions of the CRM domain may respectively comprise “volume of opportunities” and “status of opportunity.” The metrics of the Finance domain may comprise “revenue” and “growth,” with a respectively corresponding “business unit” and “region” dimension. The metrics and dimensions of the Industry domain may comprise “volume of material” and “material type,” respectively. In one embodiment, the domains may be subsets of data associated with a single business entity, while the metrics and dimensions are associated with respective ones of the domains. It will be appreciated by those of ordinary skill in the art that the Domains, Metrics, and Dimensions are useful for characterizing underlying data such that the data may be readily searched responsive to queries. Other combinations and manifestations of characterizing data for purposes of query searching is well within the scope of this disclosure.

The channels gateway 110 is communicatively coupled to the plurality of devices 115 to receive queries within a communication dialogue. In one embodiment, the plurality of devices 115 may comprise various communications devices such as mobile communications devices. The devices 115 may operate to transmit user queries in various formats, such as text, audio, video, and any combination thereof. The channels gateway 100 may comprise firmware or software configured to convert the user queries received from any of the devices 115 into a common communication format. As such, the users of the devices 115 may communicate with the data analytics system 100 via various communication channels (e.g., web-based interfaces, text messages via cellular network or a messaging service, connected voice services, or voice-over-phone to name a few). In other words, the channels gateway 110 is advantageous in that it seamlessly allows the users to generate natural language queries using any communication platform (e.g., SKYPE, SLACK, WHATSAPP, etc.) and thus provide textual, audio, or visual inputs as the queries.

The dialog manager 120 may be communicatively coupled to the channels gateway and generates search requests based on a natural language query (NLQ) received at the channels gateway 110 via one or more communication channels. The dialog manager 120 may aggregate the NLQs into conversations and store accordingly in the dialog database 130. In one embodiment, the conversation may take the form of a set of questions and associated answers directed toward particular data sets. The questions and answers may, for example, be in the form of natural language text or perhaps audio and/or visual. For example, the conversations may be stored based on context of the Domain being queried. In particular, the dialog manager 120 may implement one or more natural language processing techniques or combinations thereof to identify natural language elements from the NLQ that are relevant to search the data source 105.

FIG. 1B shows a schematic illustration of a backend process implemented by the dialog manager 120 to identify the elements relevant to the data source 105 for implementing the context-based data query, according to one illustrated embodiment.

In the FIG. 1B example, a first NLQ 505 of “What was the revenue in 2017?” may be identified as having NLQ elements “revenue” and “in 2017.” After these elements are identified, the dialog manager 120 determines that the Domain is “Finance,” Metric is “revenue,” and Dimension is “2017.” As such, the first NLQ of “What was the revenue in 2017?” may be stored in the dialog database 130 under the “Finance” context associated with a particular business entity or organization. Upon receipt of a second NLQ 510 within a same conversation as the first NLQ 505, the dialog manager may determine the second NLQ pertains to a same Domain (or context) as the first NLQ 505. In the FIG. 1B example, the second NLQ of “how about 2016?” belongs to the “Finance” domain of the data source 105, as there are no elements indicating a change in the domain from the first NLQ 505. The dialog manager may identify “2016” as an NLQ element and determine no change in domain (i.e., “Finance”) and metric (i.e., “revenue”), but that the dimension is now “2016.” Accordingly, the second NLQ may be stored in the dialog database under same “Finance” domain and “revenue” metric, but different dimension (i.e., 2016).

Upon identifying the elements of the NLQ, the dialog manager 120 converts the identified elements into a context-based data query to the analytics engine 125. The context-based data query is based on identifying a context of the NLQ in a conversation. The conversation may comprise the first and second NLQs. The context may refer to at least one of the Domain, Metric, and/or Dimension associated with a particular NLQ based on the identified elements of the NLQ in the conversation. Referring to the FIG. 1B example, the context-based data query for the first NLQ 505 may entail searching within the data source 105 for all data associated with Domain=“Finance,” Metric=“revenue,” and Dimension=“2017.” For the second NLQ example (“how about 2016?”), the context-based data query may entail an alternative search within the data source 105 for all data associated with the Domain=“Finance” and Metric=“revenue,” but with the Dimension=“2016.” In other words, the dialog manager 120 determines the identified elements of the second NLQ included a single element associated with the Dimension, and did not include elements pertaining to the Domain or Metric. Consequently, the elements from the first NLQ 505 pertaining to the Domain and Metric carry over into the second NLQ, and only the Dimension is updated from “2017” to “2016.” As such, the context of the NLQ is determined based on the identified elements of the particular NLQ and the prior NLQ in the conversation.

The analytics engine 125 may comprise firmware or software configured to run queries on the data stored in the data source 105. In particular, the analytics engine 125 may run the queries on the data source 105 responsive to the context-based data query and generate an output result. The output result for each of the context-based data queries may be converted by the dialog manager 120 into a natural language answer (NLA) and stored in the dialog database 130. For example, in each conversation, the NLQs together with the respective NLAs may be stored in the dialog database 130. The dialog database 130 may be a secured database with restricted access to users involved in the conversation. In some embodiments, to be described below, access to the dialog database 130 may granted to new users to participate in particular conversations (“share” conversations).

Responsive to the output result of the analytics engine 125 for each respective NLQ, the dialog manager 120 may generate the natural language answer (NLA) on a dashboard 145. The dashboard 145 may be controlled by the dialog manager 120 and displayed on respective ones of the devices 115 in the form of a communication dashboard between the user and the data analytics system 100. The user may enter his/her NLQ on the dashboard 145 via a selected communication format (e.g., text, voice, media), and then the channels gateway 110 may convert to the common format to generate the NLQ. The dashboard 145 may, for example, be displayed on a web browser or downloadable onto the device 115 via mobile application. Alternatively and/or additionally, the dialog manager 120 may be configured to generate a widget 140. The widget 140 may, for example, be an interactive widget operable to prompt a follow-up query on the data source via the dashboard 145. In one embodiment, the widget 140 comprises a data visualization of the output result for display within a conversation on the dashboard 145. The data visualization may include snippets of data responsive to the NLQ. As will be described below in more detail, the widget 140 may display a snippet chart of the output result from the analytics engine 125 where the snippet chart displays the searched data according to the particular context of the NLQ within the conversation. The widget 140 may prompt the user to continue the existing conversation with the system 100 in terms of refining or altering one or more of the Domain, Metric, or Dimension associated with the resultant data. The widget 140 may include drop-down selection options for the user to select from to effectively generate the follow-up query without requiring a natural language input format. It will be appreciated, that the data visualizations generated by the widget 140 responsive to the output results per NLQ may also be stored in the dialog database 130. Consequently, for each conversation, the dialog database 130 may store and organize the NLQs with associated NLAs and/or data visualizations (e.g., snippet charts, bar charts, pie charts, etc.) which can be shared with other users.

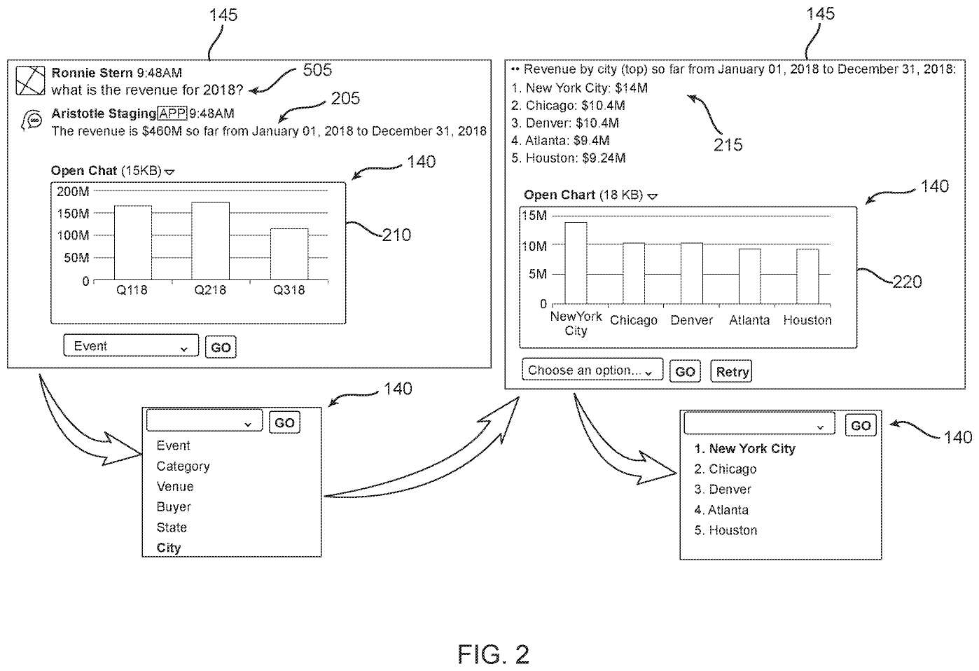

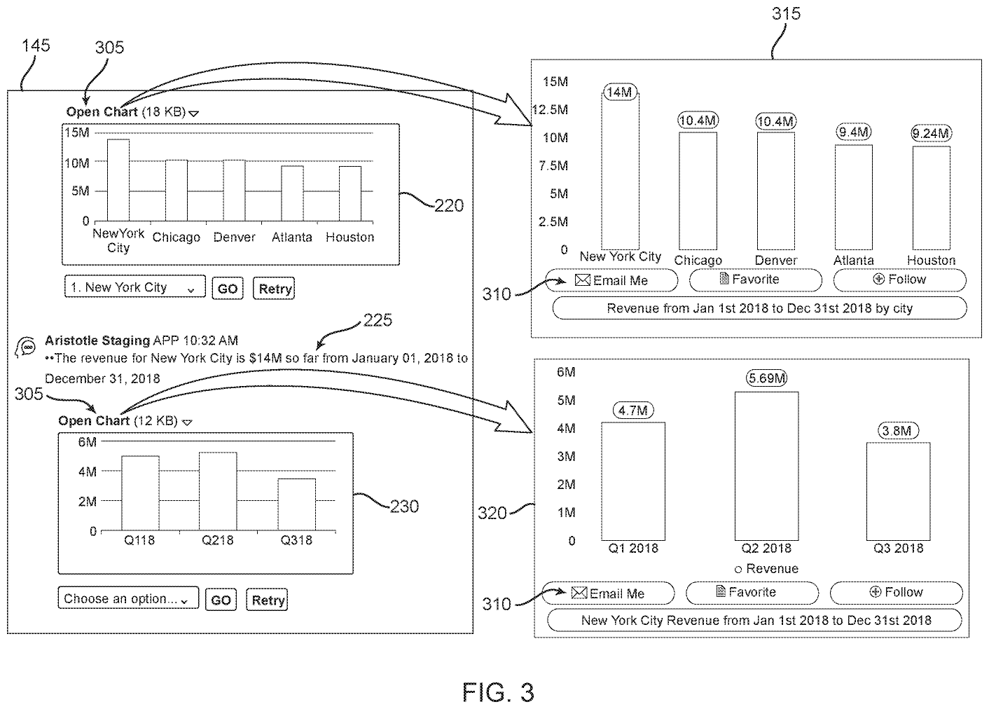

FIGS. 2-3 show screenshots from the dashboard 145 depicting the widget 140 providing follow-up analytics prompts to the user during a dialogue with the data analytics system 100, according to one illustrated embodiment.

As mentioned above, the widget 140 may be an interactive widget configured to display an interactive visual depiction of the output result from the data analytics engine 125. The dialog manager 120 is operable to control the widget 140 and its interactive display. In some embodiments, the interactive widget may display an interactive audio/visual representation of the output result. In other embodiments, the visual depiction may include various forms of graphical representation of the output result. For example, the widget 140 generates snippet charts, bar charts, pie charts, heat map, map of world, scatter plot, distributions, histogram, etc. having embedded hyperlinks for further expansion of the visualization and access to underlying data sets. The visual data may be a preview of the output result responsive to the NLQ.

The dialog manager 120 may control the widget 140 to prompt follow-up analytics actions relevant to the dialogue. The prompted follow-up analytics actions may take the form of drop-down selection options from a menu to pivot or drill down on query results. Alternatively and/or additionally, the prompted follow-up actions may be a specific recommendation to the user (e.g., “You might be interested in expenses for last year.”) The prompted follow-up actions may be based on context of the dialog, namely the elements extracted from a thread of NLQs in the particular conversation.

In the FIG. 2 illustration, an example of prompting follow-up analytics actions via a drop-down selection is depicted. In this example, the first NLQ 505 takes the form of “what is the revenue for 2018?”—a data series type query. The dialog manager 120 (illustrated in FIG. 2 as operating via an “Aristotle Staging” application) displays a first NLA 205 of “The revenue is $460M so far from Jan. 1, 2018 to Dec. 31, 2018” together with a first visual representation 210 from the widget 140 responsive to the output result. In this example, the identified elements of the NLQ are Domain=Finance; Metric=Revenue; Dimension=2018. As illustrated, the widget 140 operates to display options for follow-up analytics actions to prompt the user to pivot the output result. The follow-up actions are advantageously within the context of the dialog. For instance, here, the 2018 revenue data may be further refined or pivoted by an additional Dimension such as Event, Category, Venue, Buyer, State, or City. Alternatively and/or additionally, the user may prompt the widget 140 for follow-up analytics options. For example, the user may enter a command (e.g., “lookup”) via the dashboard 145 to actuate the widget 140 to display Dimension options and associated Filter options for the chosen Dimension. The displayed follow-up analytics options (e.g., Dimensions and Filter options) may advantageously be within the context of the dialog. For the FIG. 2 example, responsive to the user entering the command (e.g., “lookup”) for follow-up analytics options, the widget 140 operates to display Dimension options comprising “buyer, event, city, state.” Once the user selects one of the Dimension options, the user may begin to type in a Filter option as the data analytics system 100 generates possible Filter options. Upon selection of a Filter option associated with the particular Dimension, the widget 140 generates a further NLA and provides a further visual representation.

In the FIG. 2 example, upon selection of the follow-up action (“City”), the dialog manager 120 operates to cause the analytics engine 125 to run a further search on the data source 105 under same Domain, Metric, and Dimension as the first NLQ 505 (Domain=Finance; Metric=Revenue; Dimension=2018), but adds a Dimension (“City”) to pivot the data. As a result, the dialog manager 120 provides a second NLA 215 without having to receive a user input of a second NLQ. Additionally, the dialog manager 120 actuates the widget 140 to display a pivoted second visual representation 220 of the output data. In particular, the effect of selecting the follow-up action of City, results in pivoting of the output data to a breakdown of the 2018 revenue by individual City.

FIG. 3 further illustrates an example of the widget 140 prompting follow-up actions without pivoting the output result. For example, the widget 140 displays the second visual representation 220 (FIG. 2) with a drop-down of options for follow-up actions (e.g., NYC, Chicago, Denver, Atlanta, Houston). Selection of a follow-up option results in the analytics engine 125 running a further query on the data source 105 to provide a more granular retrieval of data. For instance, the selection of “NYC” as the follow-up action causes the data analytics system 100 to drill-down on the 2018 revenue data specifically for NYC. Responsive to selection of “NYC” as the follow-up action, the dialog manager 120 generates a further context-based data query to the data analytics engine 125. This time, the context-based data query on the data source 105 further drills down on the 2018 revenue by city to specifically hone in on NYC revenue for 2018. As a result, the dialog manager 120 provides a third NLA 225 without having to receive a third NLQ input from the user. Additionally, the dialog manager 120 actuates the widget 140 to display a granular visual representation 230 of the output data. In particular, the effect of selecting the follow-up action of “New York City” results in drilling down on the output data at the level of New York City. For example, the widget 140 displays a bar chart depicting quarterly revenue for New York City.

Furthermore, the widget 140 which displays the data visualization of the output data from the analytics engine, responsive to the one or more context-based data queries by the dialog manager 120, may include one or more hyperlinks 305 embedded therein. The hyperlink 305 may, for example, point to the entire data visualization (e.g., snippet chart) or one or more portions of the data visualization. In some embodiments, the hyperlink may point to the underlying data sets associated with the displayed data visualization. In the FIG. 3 illustration, the “Open Chart” comprises the hypertext of the hyperlink 305 to the data visualization. Responsive to selection of the hyperlink 305, the widget 140 may, for example, be configured to cause the data visualization to open in a new window. Opening the hyperlinked snippet chart, for example, allows for a zoomed-in display of the data visualization (e.g., snippet chart) in the new window. For example, the new window may be opened within an existing web browser hosting the dashboard 145 or in a different web browser. Alternatively and/or additionally, the data visualization may appear on a same window as the dashboard 145 within the existing web browser. It will be appreciated by those of ordinary skill in the art that various other technological methods for displaying the data visualization, responsive to selection of the hyperlink 305, are encompassed by this disclosure. The FIG. 3 illustration and associated description is merely one example implementation of displaying the data visualization.

Responsive to actuation of the hyperlink 305, the widget 140 may, for example, cause the data visualization (e.g., snippet chart) to appear in the new window and converts the visualization into an interactive display of the data. In the example of FIG. 3, the data visualization comprises a bar chart that is interactive. In this example, two bar charts are illustrated. A first bar chart 315 depicts the data visualization for the 2018 revenue, thus far, by city, while a second bar chart 320 depicts the revenue, thus far, for New York City by quarter. The first and second bar charts 315, 320 are interactive in that when the user selects one of the bars (e.g., Chicago bar in the first bar chart or Q1 2018 in the second bar chart 320), the widget 140 causes the bar chart to drill down to more granular data. For example, selecting the Chicago bar from the first bar chart 315 may update the bar chart to depict revenues per quarter for Chicago only. As another example, selection of the Q1 2018 bar from the second bar chart 320 may update the bar chart to depict New York city revenues for January-March.

Additionally, the data visualization includes one or more setting options 310. The setting options 310 may, for example, comprise EMAIL ME, FAVORITE, or FOLLOW. Any of the setting options 310 may be selected by the user. In one embodiment, the EMAIL ME setting option 310 provides for a shortcut to the user's email application. In one embodiment, the EMAIL ME setting option 310 allows for the user to email the entire dialogue with the data analytics system 100 or specific portions of the dialogue to himself/herself. In some embodiments, the EMAIL ME setting option 310 further allows for the user to email the dialogue, in whole or in part, to a third party. Additionally and/or alternatively, the underlying data sets associated with the dialogue may be transmitted via email and the like. For example, the underlying data sets may be emailed in the form of a csv file to the user or the third party.

The FAVORITE setting option 310 is configured to allow the data analytics system 100 to save the underlying one or more NLQs associated with the data visualization. The FAVORITE setting option 310 may effectively function as a shortcut to the one or more NLQs. In other words, upon selection of the FAVORITE, the dialog manager 120 may operate to regenerate the one or more NLQs and thus invoke new output results from the analytics engine 125. As described above, the dialog manager 120 may convert the output result into NLA and/or cause the widget 140 to display the data visualization of the new output result. Invoking the FAVORITE setting option 310 is advantageous in that it removes the need for the user to retrace the multiple NLQs used to achieve a particular data output result. In the FIGS. 2-3 example, the user entered into a string of conversations with the data analytics system 100 to reach the final output result of “revenue for NYC, thus far, in 2018.” Rather than retracing those steps (via the NLQ and multiple follow-up action prompts) or having to enter the specific NLQ of “what is the revenue, thus far, in 2018 for NYC?”, the user may, for example, select the associated FAVORITE—a shortcut to “what is the revenue, thus far, in 2018 for NYC?”.

The FOLLOW setting option 310 is configured to actuate the data analytics system 100 to track the data sets underlying the displayed data visualization of the widget 140. The FOLLOW setting option 310 may be associated with a particular NLQ in the communication dialog that resulted in the widget 140 displaying the data visualization. Actuation of the FOLLOW setting option 310 causes tracking of the output result resulting from the particular NLQ. In one embodiment, the FOLLOW setting option 310 may be set to track one or more of the Metrics and/or Dimensions for a particular Domain. Responsive to a change in the one or more Metrics and/or Dimensions above a defined threshold, the user may be notified. Furthermore, the user notification may additionally include at least one of an updated NLA and/or updated data visualization reflecting the change in the one or more Metrics and/or Dimensions. Additionally and/or alternatively, the dialogue may be updated to reflect the updated NLA and/or updated data visualization.

Taking FIG. 3 as an example, the FOLLOW option setting may be selected for the first bar chart 315. The user may be prompted to allow the data analytics system 100 to continuously update and notify the user upon a defined change, such as, for example, a change the data analytics system 100 determines as significant. Alternatively, the user may be given an option to define the threshold change in the Metrics and/or Dimensions that renders the notification and re-generation of the NLA and/or bar chart. For example, if the user specified to be notified when the revenue in Q3 for NYC surpasses $4M, then the data analytics system 100 will track updates to the underlying data sets (i.e., the data sets associated with Metrics=revenue; and Dimensions=2018 AND Q3 AND NYC) stored in the data source 105. Upon identifying that the Q3 revenue of NYC surpasses the defined threshold of $4M, the dialog manager 140 may transmit the notification to the user and the updated NLA (e.g., “The 2018 revenue for NYC in Q3 is now $4.1M”) and/or updated data visualization (e.g., bar chart, line chart, or pie chart) specifically depicting the NYC revenue in Q3 of 2018. It will be appreciated that the notification may be transmitted via email, text message, multi-media message, push notification, or the like and include a deep link to view the updated NLA and/or the data visualization (e.g., interactive bar chart). In another embodiment, the updated NLA may be automatically displayed upon opening of the transmitted notification upon receipt by the user.

As another example, the user may initiate the FOLLOW option and elect to receive the re-generation of the NLA and/or bar chart associated with the Q3 revenue of NYC at a defined time in the future (e.g., in one day, week, or month). In other words, the FOLLOW option may be used to re-generate the NLA and/or bar charts based on an underlying NLQ (and updated data sets in the data source 105) irrespective of what, if any, is the change in the Metrics and/or Dimensions.

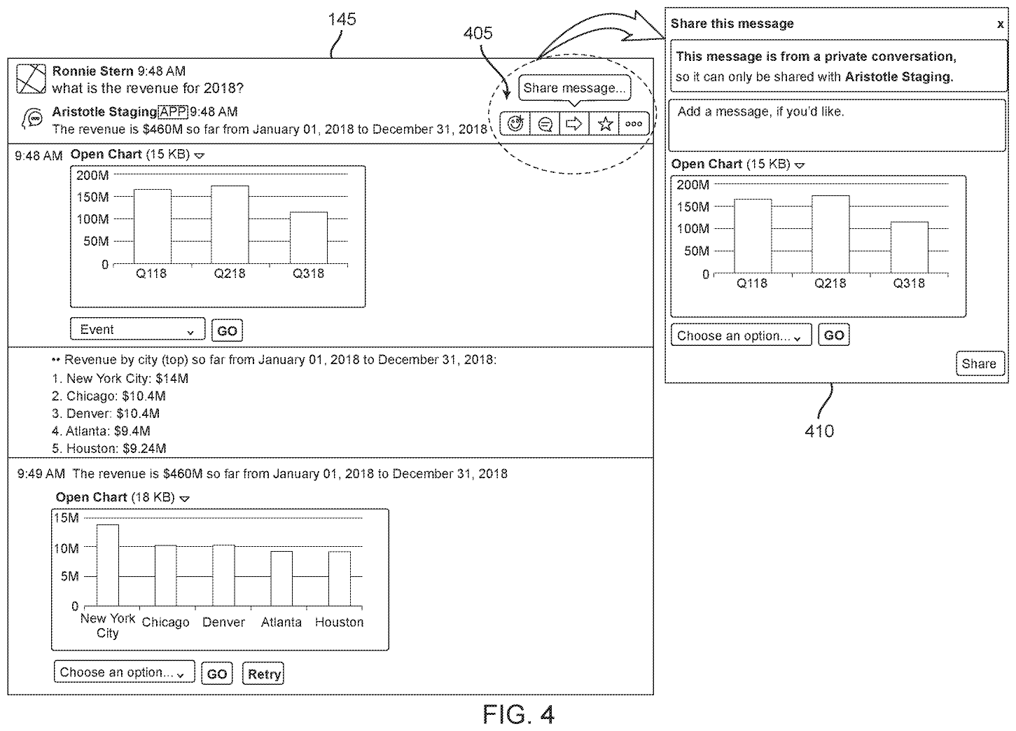

FIG. 4 shows screenshots from the dashboard 145 depicting sharing the dialogue with another user, according to one illustrated embodiment. A toolbar 405 may be embedded in the dashboard 145 and associated with one or more of the conversations. The toolbar 405 may include embedded hyperlinks. The hyperlinks may, for example, serve to add an emoji reaction, start a thread, share, or star the conversation to name a few. Additionally, the toolbar 405 may provide a deep link to a third party tool for further analysis or task management (e.g., Asana, Salesforce). In one embodiment, the dialogue between the user and the data analytics system 100 occurs in a private channel. Responsive to the user actuating the “Share message” hyperlink, the private conversation may be shared with a collaborative channel that includes other users. For example, when actuating the “Share message” hyperlink from within the private conversation on the dashboard 145, the string of NLQs, NLAs, and/or interactive data snippets may be transmitted or shared with a collaborative channel of relevant users. The embedded toolbar 405 on the dashboard 145 may advantageously allow new users to continue conversations with the data analytics system 100, as the transition of the private conversation may occur along with its context (i.e., string of NLQs, NLAs, and snippet charts).

It will be appreciated that upon selection of the “Share message” hyperlink, a share window 410 may be generated on the dashboard 145 or in a new web browser session. The share window 410 may allow the user to embed a message along with the conversation to be transitioned to the collaborative channel.

Furthermore, the widget 140 or any portion of the dashboard 145 may comprise one or more deep-links to a third party tool (e.g., Salesforce, public/private webpage, Outlook mail system, Excel, etc.). In another example, the widget 140 or portion of the dashboard 145 may comprise one or more deep-links to a system (e.g., Salesforce, Service Now, Jira, etc.) that manages a particular data set. Via the one or more deep-links, the third party tool may be configured to access the plurality of data sets stored in the data source 105. For example, the third party tool may access and/or manipulate the data sets underlying the interactive data visualization. In one embodiment, the deep-links may be embedded within the interactive data visualization whereby the user may access select portions of the snippet chart to be accessed by the third party tool. In particular, the one or more deep-links may operate to provide a link to a web page of an entity or resource corresponding to at least one of the domain, metric, or dimension used to generate the output data from the analytics engine 125. In one embodiment, the user may select one deep-link associated with a particular dimension of, for example, a sales representative. Responsive to the selection, the data analytics system 100 may link the a Salesforce page of that particular sales representative. It will be appreciated by those of ordinary skill in the art that other manifestations of third party tools via the deep-links are contemplated by this disclosure.

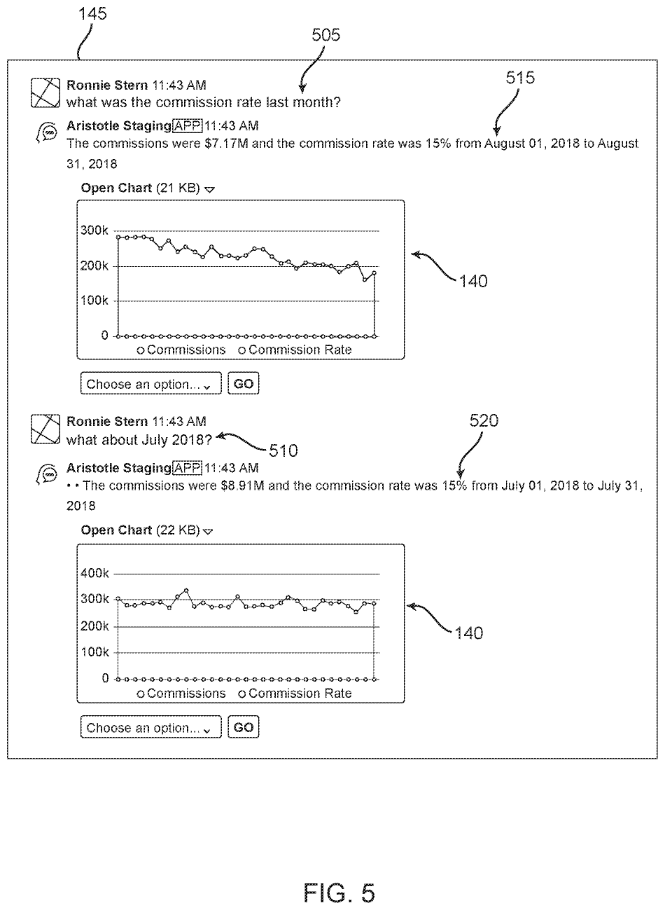

FIG. 5 shows a screenshot from the dashboard 145 depicting consecutive NLQs during the user dialogue with the data analytics system 100, according to one illustrated embodiment.

In particular, the screenshot depicted in FIG. 5 illustrates an example of follow-up queries inputted by the user by way of NLQ rather than selecting a prompted follow-up action from a drop-down menu (See, FIGS. 2-3). Furthermore, FIG. 5 illustrates an example of the dialog manager 120 identifying the elements from the NLQs and corresponding conversational characteristics of the user in the dialog.

In the illustrated embodiment, the first NLQ 505 takes the form of “what was the commission rate last month?”. Here, the dialog manager 120 may identify the first NLQ 505 elements as comprising “commission rate,” “commissions,” and “last month.” The additional element of “commissions” may be identified despite the lack of recitation of “commissions” in the first NLQ 505.

The “commission rate” element may be extracted from the NLQ itself, while “commissions” is identified responsive to training of the Artificial Intelligence (AI) based algorithm implemented via the dialog manager 120. In other words, the dialog manager 120 may be trained to recognize via its AI-based algorithm that whenever the user indicates “commission” he/she is typically also interested in the “commission rate.” Furthermore, the dialog manager 120 is operable to determine the “last month” element actually refers to August 2018. In one embodiment, the dialog manager 120 may be coupled to a real-time updated calendar server which is accessed to identify the extracted element as “last month”=August 2018.

The dialog manager 120 may, in turn, generate the context-based data query responsive to the first NLQ 505 and cause the analytics engine 125 to search the data source 105 for all associated data sets with Domain=“Finance,” Metrics=“commission” AND “commission rates” and Dimension=“August 2018.” As described above, the output result from the analytics engine 125 may be converted by the dialog manager 120 into a first NLA 515 and stored in the dialog database 130. The widget 140 may display an interactive data visualization (e.g., snippet chart).

The user may input the second NLQ 510 via the dashboard 140. Here, the second NLQ 510 takes the form of “what about July 2018?”. In other words, the user initiates a pivot of the previous output data (commission rate and commissions in August 2018) by entering the second NLQ 510, rather than selecting one of the prompted follow-up actions displayed by the widget 140 drop-down menu (as in FIGS. 2-3). Responsive to the second NLQ 510, the context-based data query initiated by the dialog manager 120 may entail a pivot from the prior search within the data source 105. In particular, the dialog manager 120 may identify a pivot in the Dimension (Dimension=“July 2018”), while the Domain and Metrics remain unchanged. Consequently, the elements from the first NLQ 505 pertaining to the Domain and Metric remain carry over into the second NLQ 510, and only the Dimension is updated from “August 2018” to “July 2018.” As such, the context of the second NLQ is determined based on the identified elements of the second NLQ and the first NLQ (prior NLQ) in the conversation.

As described above, the extrapolated elements from the second NLQ 510 is used by the analytics engine 120 to query the data source 105 and provide the output result. The dialog manager 120 receives the output result and converts it into a second NLA 520 and stores in the dialog database 130 within the same conversation. Alternatively and/or additionally, the widget 140 may display the interactive data visualization (e.g., snippet chart) of the output data stemming from the second NLQ 510.

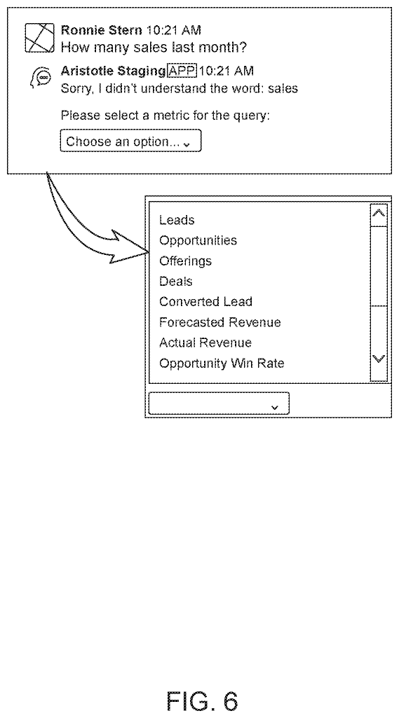

FIG. 6 shows screenshots from the dashboard 145 depicting the user dialogue with the data analytics system 100 when the dialog manager 120 prompts the user to assist in identifying an element in the NLQ, according to one illustrated embodiment.

In addition to storing the user dialog, the dialog database 130 may additionally store a set of synonyms to various ones of the identified elements. As described above, responsive to receiving the NLQ input from the user, the dialog manager 120 operates to identify the elements. The identified elements are ultimately leveraged by the dialog manager 120 to create the context-based data query to be run by the analytics engine 125 on the data source 105. In some embodiments, the identified elements are determined based on a natural language algorithm being applied to the NLQ. Responsive to the identified elements, the dialog manager 120 may access the dialog database 130 to compare the identified elements with the set of synonyms. It will be appreciated that the set of synonyms may be a predefined set of synonyms and/or set of synonyms updated in real-time as the AI-algorithm employed by the dialog manager 120 learns past behaviors of the user.

In the FIG. 6 example, the NLQ input of “How many sales last month?” is received by the dialog manager 120 via the dashboard 140. Upon receipt of the NLQ input, the dialog manager 120 runs the AI-algorithm to identify one or more elements within the NLQ. In this example, the element “sales” is identified. However, the dialog manager 120 cannot readily associate any metric stored in the data source 105 with the word “sales.” For example, the element “sales” may not have any synonyms stored in the dialog database 130. In embodiments where the element “sales” would have a synonym (e.g., revenue) stored in the dialog database 130, the “revenue” synonym may be used by the dialog manager 120 as the Metric. Because the FIG. 6 example depicts a scenario where no synonyms for “sales” is stored, the data analytics system 100 provides prompts or options for a synonym for the element “sales.” The options of synonyms may be embedded within a drop-down menu an selected by the user. Upon selection of the synonym, the dialog database 130, which stores data sets of elements with associated synonyms, adds the selected synonym as a stored synonym. As such, if a same element appears in a subsequent NLQ, the dialog manager 120 will have access to the synonym previously defined by the user and stored in the dialog database 130.

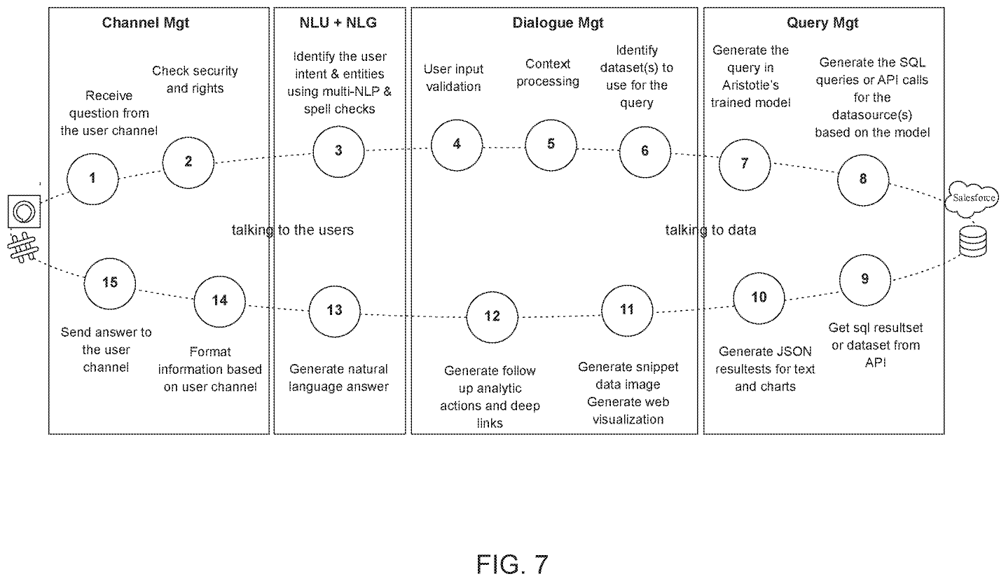

FIG. 7 is a schematic illustration of a process flow for processing an input query by the data analytics system 100, according to one illustrated embodiment.

At steps 1-2, the user enters into the data analytics system 100 the natural language query of: “Which sales rep in banking had an avg amount higher than 100K?”. The dialog manager 120 receives the question from the channel API, which parses and converts the message to a channel agnostic internal question structure. The data analytics system 100 checks if there is an active session for the user. If not it will prompt the user to login with single sign-on (SSO). Upon login, data analytics system 100 receives the user profile from the SSO and creates access security rights of the user based on his/her group.

At steps 3-5, the data analytics system 100 checks the NLQ spelling based on an algorithm that combines English language checking and metadata/data checking (e.g., misspelled words that match metadata or data are not altered). The data analytics system 100 contacts multiple natural language processors (NLPs) to get responses and synthesizes the best of all NLPs responses as intents and entities. For example, input validation may identify the user hasn't defined the date range in his/her NLQ (i.e., question). If the user forgot a date range, the data analytics system 100 will ask the user to set the date range for his/her NLQ. In one example, the user sets the date range as “last quarter”. Consequently, based on this dialog, the intent may be updated with the date/time and grain. It will be appreciated the grain may be used by the data analytics system 100 to generate the response.

At step 6, a context manager (the dialog manager 120) identifies the user's NLQ as a new query and not a follow-up to a previous conversation. As such, the dialog manager 120 creates a new context for the user and updates the user's dialog history in the dialog database 130. Additionally, the new query is processed as input to user personalization. A dataset resolution module identifies which skill(s)/dataset(s) can answer the question. The dataset resolution module chooses the one that best matches the identified intent and Responsive to a tie, the conversation history is taken into account. Taking into consideration the synonyms and formulas as identified in the question, the data analytics system 100 creates an internal JSON representation of the query and sends it to the query management module.

At steps 7-10, the query module processes the generic JSON query and generates the SQL that can run against the data source linked to the skill. The corresponding data driver converts the SQL to SAQL in order to send the query to run as in-database analysis by the underlying data system. Using a connector native to the data source, it may send the corresponding commands in, for example, Einstein Analytics. It will be appreciated that Einstein Analytics is just one example and other analytics tools are well within the scope of this disclosure.

At steps 11-13, the process includes (i) generating snippet data image and generating data visualization via, for example, the web; (ii) generating follow up analytic actions and deep-links; and (iii) generating the natural language answer (NLA).

Finally, at steps 14-15, the data analytics system 100 converts the channel agnostic response to a channel specific implementation. For example, the data analytics system 100 may convert the pivot options, which are to be presented to the user, into a drop down list in Slack, quick response buttons in Salesforce Lightning, and a list template in Alexa. The data analytics system 100 sends the response using the channel's proprietary API with a direct channel integration.

It will be appreciated that the process flow for processing an input query discussed above may be implemented in a different order, concurrently, may include additional steps, or may refrain from implementing some of the steps. The above description of the process flow and the illustration of FIG. 7 are for mere illustration of one embodiment and may be implemented using other components.

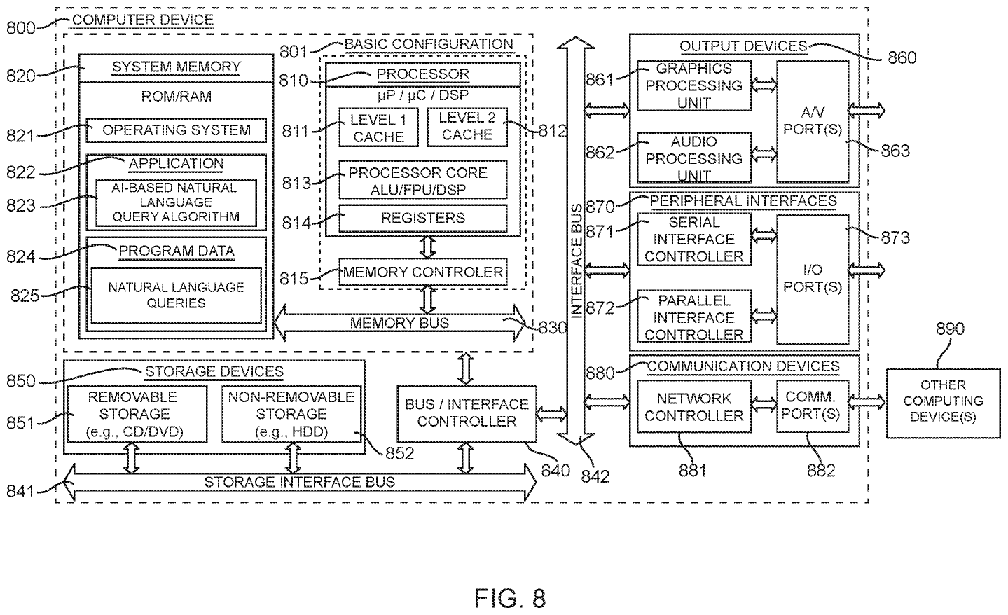

FIG. 8 shows a block diagram illustrating an example dialog manager 120 arranged for identifying the NLQ elements relevant for generating context-based query of the data sets in the data source 105 and causing display of a data visualization of the searched data with prompts for follow-up searches, according to one illustrated embodiment.

FIG. 8 is a block diagram illustrating an example dialog manager 120 in the form of a computer device 800 arranged for determining one or more elements from a NLQ, generating context-based data query of the data sets in the data source 105, and causing display of a data visualization (e.g., snippet chart) of the searched data with prompts for follow-up actions and/or a natural language answer (NLA), in accordance with the present disclosure. In a very basic configuration 801, the computer device 800 typically includes one or more processors 810 and system memory 820. A memory bus 830 may be used for communicating between the processor 810 and the system memory 820.

Depending on the desired configuration, processor 810 may be of any type including but not limited to a microprocessor (μP), a microcontroller (μC), a digital signal processor (DSP), a graphics processing unit (GPU) or any combination thereof. Processor 810 may include one more levels of caching, such as a level one cache 811 and a level two cache 812, a processor core 813, and registers 814. An example processor core 813 may include an arithmetic logic unit (ALU), a floating point unit (FPU), a digital signal processing core (DSP Core), or any combination thereof. An example memory controller 815 may also be used with the processor 810, or in some implementations the memory controller 815 may be an internal part of the processor 810.

Depending on the desired configuration, the system memory 820 may be of any type including but not limited to volatile memory (such as RAM), non-volatile memory (such as ROM, flash memory, etc.) or any combination thereof. System memory 820 may include an operating system 821, one or more applications 822, and program data 824. Application 822 may include an AI-based natural language query algorithm that is arranged to identify the one or more elements of the NLQ. Program Data 824 includes one or more NLQs received via the dashboard 140 that is useful to generate the context-based data query by the dialog manager 120 to run a search on the source data 105 via the analytics engine 125, as described above. In some embodiments, application 822 may be arranged to operate with program data 824 on an operating system 821 such that the dashboard 140 displays the data visualization (e.g., snippet chart) of the searched data with prompts for follow-up actions and/or a natural language answer (NLA) to the NLQ. This described basic configuration is illustrated in FIG. 8 by those components within dashed line 801.

The computer device 800 may have additional features or functionality, and additional interfaces to facilitate communications between the basic configuration 801 and any required devices and interfaces. For example, a bus/interface controller 840 may be used to facilitate communications between the basic configuration 801 and one or more data storage devices 850 via a storage interface bus 841. The data storage devices 850 may be removable storage devices 851, non-removable storage devices 852, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 820, removable storage 851 and non-removable storage 852 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computer device 800. Any such computer storage media may be part of device 800.

Computer device 800 may also include an interface bus 842 for facilitating communication from various interface devices (e.g., output interfaces, peripheral interfaces, and communication interfaces) to the basic configuration 801 via the bus/interface controller 840. Example output devices 860 include a graphics processing unit 861 and an audio processing unit 862, which may be configured to communicate to various external devices such as a display or speakers via one or more A/V ports 863. Example peripheral interfaces 870 include a serial interface controller 871 or a parallel interface controller 872, which may be configured to communicate with external devices such as input devices (e.g., keyboard, mouse, pen, voice input device, touch input device, etc.) or other peripheral devices (e.g., printer, scanner, etc.) via one or more I/O ports 873. An example communication device 880 includes a network controller 881, which may be arranged to facilitate communications with one or more other computing devices 890 (e.g., user devices 115) over a network communication link via one or more communication ports 882.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computer device 800 may be implemented as a portion of a small-form factor portable (or mobile) electronic device such as a cell phone, a personal media player device, a wireless web-watch device, a personal headset device, an application specific device, or a hybrid device that includes any of the above functions. Computer device 800 may also be implemented as a personal computer including both laptop computer and non-laptop computer configurations. In another example, the computer device 800 may be a cloud-based server system embedded within the data analytics system 100.

The figures along with the following discussion provide a brief, general description of a suitable environment in which embodiments of the invention can be implemented. Although not required, aspects of various embodiments are described below in the general context of computer-executable instructions, such as routines executed by a general purpose data processing module, e.g., a networked server computer, cloud server, mobile device, tablet, or personal computer. Those skilled in the relevant art will appreciate that embodiments can be practiced with other communications, data processing, or computer system configurations, including: Internet appliances, hand-held devices (including smart phones, tablets, notebooks, wearable computers, all manner of corded, landline, fixed line, cordless, cellular or mobile phones, smart phones, multi-processor systems, microprocessor-based or programmable consumer electronics, set-top boxes, network PCs, mini-computers, mainframe computers, media players and the like. Indeed, the terms “computer,” “server,” and the like are generally used interchangeably herein, and refer to any of the above devices and systems, as well as any data processor.

While embodiments of the invention, such as certain functions, may be described as being performed on a single device, embodiments of the invention can also be practiced in distributed environments where functions or modules are shared among disparate processing devices, which are linked through a communications network, such as, for example, a Local Area Network (LAN), Wide Area Network (WAN), the Internet, Bluetooth, and Zigbee. In a distributed computing environment, program modules may be located in both local and remote memory storage devices.

Embodiments of the invention may be stored or distributed on tangible computer-readable media, including magnetically or optically readable computer discs, cloud servers, hard-wired or preprogrammed chips (e.g., EEPROM semiconductor chips), nanotechnology memory, biological memory, or other data storage media. Alternatively or additionally, computer implemented instructions, data structures, screen displays, and other data under aspects of embodiments of the invention may be distributed over the Internet and via cloud computing networks or on any analog or digital network (packet switched, circuit switched, or other scheme).

The computer readable medium stores computer data, which data may include computer program code that is executable by a computer, in machine readable form. By way of example, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

Embodiments of the invention are described herein with reference to operational illustration of modules, managers, widgets, and/or engines having functional blocks to illustrate methods employed by the modules managers, widgets, and/or engines to receive natural language queries and provide a context-based response, including as interactive data visualization with one or more prompts for follow-up queries. It will be understood that each of the modules, blocks, engines, and combinations thereof may be implemented by analog or digital hardware and computer program instructions. The computer program instructions may be provided to a processor of a general purpose computer, special purpose computer, application-specific integrated circuit (ASIC), or other programmable data processing apparatus such that the instructions, which execute via the processor of the computer or other programmable data processing apparatus, implements the functions/acts specified in the functional blocks of the flowcharts, screenshots, and/or the operational modules.

In some embodiments, the methods illustrated by the screenshots or functional blocks may occur out of the order noted in the operational illustration of the modules. For example, two blocks or screenshots shown in succession may be executed substantially concurrently. Alternatively and/or additionally, the blocks or screenshots may be executed in reverse order.

A module, manager, or widget is a software, hardware, or firmware (or combination thereof) system, process or functionality, or component thereof, that performs or facilitates the processes, features, and/or functions described herein. A module may include sub-modules or engines. Software components of a module may be stored on a computer readable medium. Modules may be integral to one or more servers, or be loaded and executed by one or more servers. One or more modules may be grouped into an application. A widget may an element of a graphical user interface (GUI) that displays information or provides a specific way for a user to interact with the operating system or an application.

The present disclosure is not to be limited in terms of the particular examples described in this application, which are intended as illustrations of various aspects. Many modifications and examples can be made without departing from its spirit and scope, as will be apparent to those skilled in the art. Functionally equivalent methods and apparatuses within the scope of the disclosure, in addition to those enumerated herein, will be apparent to those skilled in the art from the above descriptions. Such modifications and examples are intended to fall within the scope of the appended claims. The present disclosure is to be limited only by the terms of the appended claims, along with the full scope of equivalents to which such claims are entitled. It is to be understood that this disclosure is not limited to particular methods, which can, of course, vary. It is also to be understood that the terminology used herein is for the purpose of describing particular examples only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

It will be further understood by those within the art that if a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

Furthermore, in those instances where a convention analogous to “at least one of A, B, and C, etc.” is used, in general, such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general, such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 items refers to groups having 1, 2, or 3 items. Similarly, a group having 1-5 items refers to groups having 1, 2, 3, 4, or 5 items, and so forth.

1. A data analytics system, comprising:
a data storage device configured to store a plurality of data sets associated with at least one of a domain, metric, or dimension;
a processor to generate a context-based data query responsive to identifying a context of a natural language query based, at least in part, on a prior natural language query within a conversation; and
an analytics server configured to run queries on the data storage device responsive to the context-based data query and generate a data output result,
wherein the processor is configured to generate a natural language answer or a data visualization of the data output result and to generate a selection of data query options, and
wherein the analytics server performs a search of the domain, metric, or dimension upon which the data output result was generated, according to one of the data query options selected by a user.

2. The system of claim 1, wherein the processor generates the natural language answer to the natural language query based on the data output result from the analytics server.

3. The system of claim 1, further comprising a widget to display the selection of data query options.

4. The system of claim 3, wherein the widget displays the data visualization of the data output result with the prompt for the follow-up query on the data storage device, wherein the data visualization is an interactive data visualization.

5. The system of claim 4, wherein the analytics server performs the follow-up query on the data storage device responsive to selection of the follow-up query via the widget, the follow-up query alters one or more of the domain, metric, or dimension used to search the data sets.

6. The system of claim 4, wherein the widget comprises one or more deep-links to a third party tool.

7. The system of claim 6, wherein the third party tool is configured to access the data sets underlying the interactive data visualization.

8. The system of claim 6, wherein the one or more deep-links provide a link to at least one of a web-page or mobile application page of an entity corresponding to at least one of the domain, metric, or dimension used to generate the data output result.

9. The system of claim 2, further comprising a dialogue database to store the conversation, including at least one of the natural language query, the natural language answer, and the data visualization of the data output result.

10. The system of claim 9, wherein a widget comprises an option to share the conversation in a separate communication channel.

11. The system of claim 10, wherein the widget operates to provide the separate communication channel with access to the dialog database to retrieve one or more of the natural language question, the natural language answer, and the data visualization.

12. The system of claim 4, wherein the interactive widget comprises a FAVORITE setting option configured to save the natural language query as a shortcut.

13. The system of claim 12, wherein the FAVORITE is configured to automatically regenerate the saved natural language query responsive to selection of the FAVORITE.

14. The system of claim 4, wherein the interactive widget includes a FOLLOW setting option, wherein actuation of the FOLLOW setting option associated with the natural language query or the data visualization in the conversation causes tracking of the underlying plurality of data sets.

15. The system of claim 14, wherein responsive to a change of one of the metric or dimension above a threshold, the processor displays an updated natural language answer and associated data visualization.

16. The system of claim 1, wherein the data visualization includes a data snippet having one or more hyperlinks to access interactive charts associated with the data visualization and underlying data metrics.

17. The system of claim 1, further comprising a channels gateway configured to receive the natural language query via one or more communication protocols and convert to a common protocol.

18. A tangible computer readable medium having a memory and instructions stored therein that when executed by a processor performs a method comprising:
receiving a natural language query;
identifying one or more elements of the natural language query and converting to one or more of a domain, metric, and dimension, wherein the one or more elements of the natural language query are based, at least in part, on a prior natural language query within a conversation;
generating a context-based data query to be run on data sets associated with the one or more of the domain, metric, or dimension to receive an output search result;
generating a natural language answer or a data visualization of the output search result; and
displaying data query options, wherein responsive to selection of one of the data query options by a user, performing a search of the domain, metric, or dimension upon which the output search result was generated.

19. The tangible computer readable medium of claim 18, further comprising generating the natural language answer to the natural language query based on the output search result.

20. The tangible computer readable medium of claim 18, further comprising deep-linking a third party tool to provide access to the data sets underlying the data visualization.
